(19) United States
(12) Patent Application Publication
(10) Pub. No.: US 2022/0391752 A1
(43) Pub. Date: Dec. 8, 2022

(54) GENERATING LABELED SYNTHETIC IMAGES TO TRAIN MACHINE LEARNING MODELS

(71) Applicant: X Development LLC, Mountain View, CA (US)

(72) Inventors: Elliott Grant, Woodside, CA (US); Kangkang Wang, San Jose, CA (US); Bodi Yuan, Sunnyvale, CA (US); Zhiqiang Yuan, San Jose, CA (US)

(21) Appl. No.: 17/342,196

(22) Filed: Jun. 8, 2021

(51) Int. Cl. G06N 20/00; G06K 9/62; G06N 5/04; G06Q 50/02

(52) U.S. Cl. CPC G06N 20/00; G06K 9/6256; G06N 5/04; G06Q 50/02

(57) ABSTRACT

Implementations are described herein for automatically generating labeled synthetic images that are usable as training data for training machine learning models to make an agricultural prediction based on digital images. A method includes: generating a plurality of simulated images, each simulated image depicting one or more simulated instances of a plant; for each of the plurality of simulated images, labeling the simulated image with at least one ground truth label that identifies an attribute of the one or more simulated instances of the plant depicted in the simulated image, the attribute describing both a visible portion and an occluded portion of the one or more simulated instances of the plant depicted in the simulated image; and training a machine learning model to make an agricultural prediction using the labeled plurality of simulated images.

### BACKGROUND

Numerous factors may impact crop yield, such as temperature, precipitation, humidity, as well as other naturally-occurring factors such as disease, animals and insects, soil composition and/or quality, and availability of sunlight, to name a few. Human-induced factors are myriad, and include application of pesticides, application of fertilizers, crop rotation, applied irrigation, soil management, crop choice, and disease management, to name a few.

One source of observational crop data is farm machinery, which are becoming increasingly sophisticated. For example, some tractors and harvesters are configured to automatically collect and log various data, such as digital images of crops, where they were operated (e.g., using position coordinate data). In some cases, tractor-generated and harvester-generated data may be uploaded by one or more tractors and harvesters (e.g., in real time or during downtime) to a central repository of tractor-generated and harvester-generated data. Agricultural personnel such as farmers or entities that analyze crop yields and patterns may utilize this data for various purposes.

Various types of machine learning models can be trained to make agricultural predictions (e.g., to predict crop yield) based on digital images of crops. Regression models are one example. However, the accuracies of these machine learning models depends largely on the amount of training data used to train them. Annotating training images can be prohibitively costly, especially where the images are annotated on a pixel-wise basis. Additionally, it can take a significant amount of time to gather enough ground truth data to train a machine learning model to make agricultural predictions based on digital images of crops. For example, it may take an entire growing season to obtain time series images of plants to use as ground truth data to train the model. Furthermore, it may take multiple years to obtain time series images of plants over multiple growing seasons, in order to train the model with this additional ground truth data.

### SUMMARY

Implementations are described herein for automatically generating labeled synthetic (simulated) images that are usable as training data for training machine learning models to make agricultural predictions (e.g., to predict crop yield) based on digital images. In various implementations, one or more machine learning models, such as a regression model, may be trained to generate output that is indicative, for instance, of predicted crop yield, predicted plant biotic or abiotic stress, predicted crop type classifications, estimated maturity stage, predicted lodging, crop loss, harvest time, etc. Inputs to such a model may include digital images of crops (e.g., images collected by tractors and harvesters).

Training data may be generated to train the one or more machine learning models by generating three-dimensional (3D) simulated instances of a plant and then generating simulated images that are two-dimensional (2D) projections of one or more of the simulated instances of the plant. The simulated images may then be labeled (annotated) with at least one ground truth label that identifies an attribute of the one or more simulated instances of the plant depicted in the simulated image. Annotation of these simulated images can be performed automatically as part of the generation process, at a per-pixel level or using bounding shapes. Because the 2D projections are based on 3D simulated instances of plant, various attributes of the 2D projections are known, such as counts of leaves, fruits, flowers, etc., regardless of whether some of those are partially or wholly occluded (e.g., hidden from view by other portions of the plant) in the 2D projections. Thus, the attribute of a simulated instance of a plant may describe both a visible portion and an occluded portion of the one or more simulated instances of the plant depicted in the simulated image.

The one or more machine learning models may then be trained using the training data to map 2D data in which one or more attributes are at least partially occluded (and hence, not directly detectable in the 2D imagery) to ground truth data in which the attributes are entirely known. As a result, when the machine learning model(s) are used to process real-world 2D imagery depicting plants with various attributes (e.g., counts of fruit, leaves, flowers, etc.) at least partially occluded, output of the machine learning model(s) may predict or estimate the attributes in their entireties, including both visible and occluded portions.

In various implementations, a method implemented by one or more processors may include generating a plurality of simulated images, each simulated image depicting one or more simulated instances of a plant; for each of the plurality of simulated images, labeling the simulated image with at least one ground truth label that identifies an attribute of the one or more simulated instances of the plant depicted in the simulated image, wherein the attribute describes both a visible portion and an occluded portion of the one or more simulated instances of the plant depicted in the simulated image; and training a machine learning model to make an agricultural prediction using the labeled plurality of simulated images.

In some implementations, the at least one ground truth label identifies a number of leaves, fruits, flowers, or pods on the one or more simulated instances of the plant depicted in the simulated image. In some implementations, the at least one ground truth label identifies a weight or volume yield associated with the one or more simulated instances of the plant depicted in the simulated image. In some implementations, the plurality of simulated images comprises images having different instances of camera occlusion. In some implementations, a distribution of the different instances of camera occlusion is determined using real-life yield data.

In some implementations, the plurality of simulated images include images simulating a plurality of camera angles. In some implementations, the plurality of simulated images include images of simulated instances of plants grown in a plurality of different configurations. In some implementations, the plurality of simulated images include images of simulated instances of plants that are lodged. In some implementations, the plurality of simulated images include simulated thermal images. In some implementations, the plurality of simulated images include simulated near-infrared images.

In some additional or alternative implementations, a computer program product may include one or more non-transitory computer-readable storage media having program instructions collectively stored on the one or more computer-readable storage media. The program instructions may be executable to: generate a plurality of three-dimensional simulated instances of a plant; generate training data comprising a plurality of simulated images, each simulated image being a two-dimensional projection of one or more of the simulated instances of the plant; for each of the plurality of simulated images in the training data, labeling the simulated image with at least one ground truth label that identifies an attribute of the one or more simulated instances of the plant depicted in the simulated image, wherein the attribute describes both a visible portion and an occluded portion of the one or more simulated instances of the plant depicted in the simulated image; and train a regression model to make an agricultural prediction using the training data.

In some implementations, the at least one ground truth label identifies leaf sizes, leaf shapes, leaf spatial and numeric distributions, branch sizes, branch shapes, flower size, or flower shapes on the one or more simulated instances of the plant depicted in the simulated image.

In some additional or alternative implementations, a system may include a processor, a computer-readable memory, one or more computer-readable storage media, and program instructions collectively stored on the one or more computer-readable storage media. The program instructions may be executable to: generate a plurality of simulated images, each simulated image depicting one or more simulated instances of a plant; for each of the plurality of simulated images, label the simulated image with at least one ground truth label that identifies an attribute of the one or more simulated instances of the plant depicted in the simulated image, wherein the attribute describes both a visible portion and an occluded portion of the one or more simulated instances of the plant depicted in the simulated image; and train a regression model to make an agricultural prediction using the labeled plurality of simulated images.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 schematically depicts an example environment in which selected aspects of the present disclosure may be employed in accordance with various implementations.

FIG. 2 schematically depicts components and a process for practicing selected aspects of the present disclosure, in accordance with various implementations.

FIG. 3 depicts a flowchart illustrating an example method for practicing selected aspects of the present disclosure.

FIG. 4 depicts another flowchart illustrating an example method for practicing selected aspects of the present disclosure.

FIG. 5 schematically depicts an example architecture of a computer system.

### DETAILED DESCRIPTION

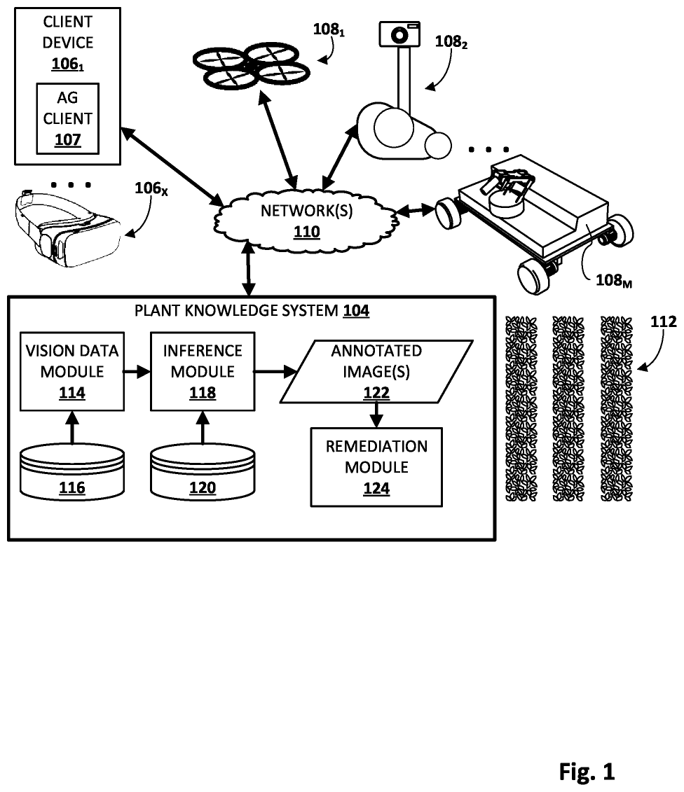

FIG. 1 schematically illustrates an environment in which one or more selected aspects of the present disclosure may be implemented, in accordance with various implementations. The example environment includes one or more agricultural areas 112 and various equipment that may be deployed at or near those areas, as well as other components that may be implemented elsewhere, in order to practice selected aspects of the present disclosure. Various components in the environment are in communication with each other over one or more networks 110. Network(s) 110 may take various forms, such as one or more local or wide area networks (e.g., the Internet), one or more personal area networks (“PANs”), one or more mesh networks (e.g., ZigBee, Z-Wave), etc.

Agricultural area(s) 112 may be used to grow various types of crops that may produce plant parts of economic and/or nutritional interest. Agricultural area(s) 112 may include, for instance, one or more crop fields, one or more plots, one or more gardens, one or more greenhouses, or any other areas in which there may be an interest or desire to automatically detect, classify, and/or segment plants having particular targeted traits. Plant traits may take various forms, including but not limited to plant types (e.g., genus, species, variety, etc.), plant gender, various observable characteristics of a plant resulting from an interaction of the plant's genotype with its environment (“phenotype”), plant disease, stage of growth, presence/absence of some targeted gene/gene sequence, etc. As one non-limiting example, there may be considerable interest and/or benefit in automatically detecting plants having a trait of being “undesirable” (sometimes such plants are referred to as “weeds”) in an area 112 in which other desired plants are being grown. Once detected, various remedial actions may be taken, such as flagging the weeds' locations for removal or treatment (e.g., herbicide application) by agricultural personnel and/or farming equipment.

An individual (which in the current context may also be referred to as a “user”) may operate one or more client devices 106_{1-X} to interact with other components depicted in FIG. 1. A client device 106 may be, for example, a desktop computing device, a laptop computing device, a tablet computing device, a mobile phone computing device, a computing device of a vehicle of the participant (e.g., an in-vehicle communications system, an in-vehicle entertainment system, an in-vehicle navigation system), a standalone interactive speaker (with or without a display), or a wearable apparatus that includes a computing device, such as a head-mounted display (“HMD”) 106_{X} that provides an AR or VR immersive computing experience, a “smart” watch, and so forth. Additional and/or alternative client devices may be provided.

Plant knowledge system 104 is an example of an information system in which the techniques described herein may be implemented. Each of client devices 106 and plant knowledge system 104 may include one or more memories for storage of data and software applications, one or more processors for accessing data and executing applications, and other components that facilitate communication over a network. The operations performed by client device 106 and/or plant knowledge system 104 may be distributed across multiple computer systems.

Each client device 106 may operate a variety of different applications that may be used to perform various agricultural tasks, such as agricultural prediction and diagnosis. For example, a first client device 106₁ operates agricultural (“AG”) client 107 (e.g., which may be standalone or part of another application, such as part of a web browser). Another client device 106_{X} may take the form of a HMD that is configured to render 2D and/or 3D data to a wearer as part of a VR immersive computing experience. For example, the wearer of client device 106_{X} may be presented with 3D point clouds representing various aspects of objects of interest, such as fruits of crops, weeds, agricultural predictions, etc. The wearer may interact with the presented data, e.g., using HMD input techniques such as gaze directions, blinks, etc.

In some implementations, AG client 107 may be used to communicate to agricultural personnel instructions and/or information that can help them perform various agricultural tasks. For example, a remediation module 124 (described in more detail below) may generate a report, a map, instructions, and/or any other data that may be presented to an operator of a client device using a graphical user interface, audibly, etc. These data may inform the agricultural personnel where plants having targeted traits (e.g., weeds, diseased plants, plants have desired characteristics, etc.) are located, what action(s) should be taken on those plants, a timeframe in which those action(s) should be taken, etc.

In some implementations, one or more robots 108_{1-M} may be deployed to perform various agricultural tasks. Performance of some of these tasks—including but not limited to weed remediation, plant harvesting, etc.—may be performed using machine learning model(s) trained on synthetic training data created using techniques described herein. An individual robot 108_{1-M} may take various forms, such as an unmanned aerial vehicle 108₁, a robot (not depicted) that is propelled along a wire, track, rail or other similar component that passes over and/or between crops, wheeled robots 108₂ to 108_{M}, or any other form of robot capable of being propelled or propelling itself past crops of interest.

In some implementations, different robots may have different roles, e.g., depending on their capabilities. For example, in some implementations, one or more of robots 108_{1-M} may be designed to capture data, others may be designed to manipulate plants or perform physical agricultural tasks, and/or others may do both. Robots 108 may include various types of sensors, such as vision sensors (e.g., 2D digital cameras, 3D cameras, 2.5D cameras, infrared cameras, etc.), inertial measurement unit (“IMU”) sensors, Global Positioning System (“GPS”) sensors, X-ray sensors, moisture sensors, lasers, barometers (for local weather information), photodiodes (e.g., for sunlight), thermometers, etc.

In various implementations, plant knowledge system 104 may be implemented across one or more computing systems that may be referred to as the “cloud.” Plant knowledge system 104 may receive vision data generated by robots 108_{1-M} (and/or robots at other agricultural sites) and process it using various image processing techniques to perform tasks such as detection, classification, and/or segmentation of plants having targeted traits. In various implementations, plant knowledge system 104 may include a vision data module 114 and an inference module 118. In some implementations one or more of modules 114 and 118 may be omitted, combined, and/or implemented in a component that is separate from plant knowledge system 104.

Plant knowledge system 104 may also include one or more databases. For example, plant knowledge system 104 may include, in communication with vision data module 114, an imagery database 116 for storing image data captured by, for instance, agricultural personnel and/or one or more robots 108_{1-M}. Plant knowledge system 104 may also include a machine learning model database 120 that includes one or more machine learning models that are trained based on synthetic training data generated using techniques described herein. In this specification, the term “database” and “index” will be used broadly to refer to any collection of data. The data of the database and/or the index does not need to be structured in any particular way and it can be stored on storage devices in one or more geographic locations.

Vision data module 114 may be configured to obtain digital images and/or other imagery data from various sources, such as imagery database 116 purposed as an imagery clearinghouse, as well as from sources such as robots 108_{1-M}. Vision data module 114 may then provide these imagery data to inference module 118. In other implementations, vision data module 114 may be omitted and the functions described herein as being performed by vision data module 114 may be performed by other components of plant knowledge system 104, such as inference module 118.

Inference module 118 may be configured to apply imagery data received from vision data module 114 as input across various machine learning models stored in machine learning model database 120 to generate output. This output may be indicative of an agricultural prediction (e.g., predicted crop yield) and/or of plants having targeted traits that are detected, segmented, and/or classified in imagery data received from vision data module 114. To this end, machine learning models stored in database 120 may be trained to make an agricultural prediction (e.g., predicted crop yield, predicted plant biotic or abiotic stress, predicted crop type classifications, estimated maturity stage, predicted lodging, crop loss, harvest time, etc.) and/or to detect, classify, and/or segment plants with targeted traits, such as two-dimensional digital images of agricultural area(s) 112 captured by agricultural personnel and/or by robot(s) 108.

Various types of machine learning models may be trained, e.g., using labeled synthetic (simulated) images that are automatically generated using techniques described herein, to make an agricultural prediction (e.g., predicted crop yield, predicted plant biotic or abiotic stress, predicted crop type classifications, estimated maturity stage, predicted lodging, crop loss, harvest time, etc.) based on imagery data of crops. In some implementations, a regression model may be trained to generate output indicative of the agricultural prediction. In FIG. 1, for instance, inference module 118 may make an agricultural prediction for one or more plants, crop fields or rows or areas within a crop field, one or more plots, one or more gardens, one or more greenhouses, or any other areas.

In some implementations, inference module 118 generates annotated image(s) 122 that include pixel-wise annotations identifying one or more plants, crop fields or rows or areas within a crop field, one or more plots, one or more gardens, one or more greenhouses, or any other areas based on predicted yield and/or targeted traits. These pixel-wise annotations may be used, for instance, to segment the digital image into portions showing plants, fields, etc. based on predicted yield or targeted traits, such as weeds, diseased plants, plants having some desired characteristic, etc. In some such implementations, a remediation module 124 may be configured to take remedial action using these annotated and/or segmented images 122. For example, in some implementations, remediation module 124 may deploy one or more robots 108 to take remedial action on the plants detected as having the detected traits, such as pulling weeds, spraying weeds with chemicals, destroying weeds using other mechanical and/or energy-based means, harvesting desired plant parts (e.g., fruits, flowers, etc.), and so forth. In other implementations, inference module 118 may output one or more probabilities that one or more plants having targeted traits are detected in an image. In some implementations, remediation module 124 may provide output that includes, for instance, a map of plants having a targeted trait, e.g., for remediation or other action by agricultural personnel.

In some implementations, one or more components of plant knowledge system 104 may be implemented in whole or in part on a robot 108. For example, inference module 118 may be implemented in whole or in part on a robot 108 that is also equipped with a vision sensor such as a two-dimensional camera. By having an onboard inference module 118, robot 108 may be able to process its own images to quickly detect plants having targeted traits. Robot 108 may also include its own remediation module 124 that enables robot 108 to take remedial action.

As noted previously, obtaining sufficient ground truth training data to train machine learning model(s) such as regression models to make an agricultural prediction may be resource-intensive and/or difficult. In particular, annotating training images can be prohibitively costly, especially where the images are annotated on a pixel-wise basis. Additionally, it may take an entire growing season to obtain time series images of plants to use as ground truth data to train the model, and it may take multiple years to obtain time series images of plants over multiple growing seasons, in order to train the model with this additional ground truth data. Accordingly, techniques are described herein for automatically generating labeled synthetic (simulated) images that are usable as training data for training machine learning models to make an agricultural prediction based on digital images.

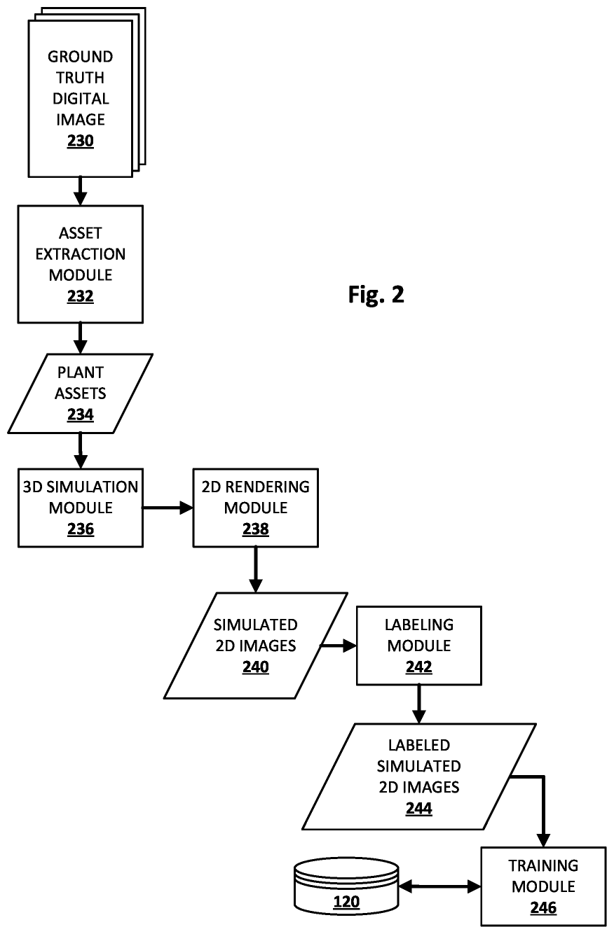

FIG. 2 depicts an example process pipeline for generating labeled simulated images that are usable as training data for training machine learning models to make an agricultural prediction (e.g., to predict crop yield) in accordance with various implementations described herein. Various components depicted in FIG. 2 may be implemented using any combination of software and hardware, and in some cases may be implemented as part of plant knowledge system 104. Starting at top left, one or more ground truth digital images 230 depicting plants having targeted trait(s) may be captured and/or retrieved from a database. These images may be captured, for instance, by robots 108_{1-M} and/or by agricultural personnel, and/or may be stored in and retrieved from a database such as imagery database 116.

An asset extraction module 232 may be configured to process digital image(s) 230 in order to classify and/or segment individual plants, and parts of those individual plants (e.g., stems, leaves, flowers, fruit, etc.). This segmentation may allow for extraction of individual plants and/or plant parts for use as “plant assets” 234. Plant assets 234 may be stored in a database (not depicted) and used subsequently to generate simulated imagery of plants having desired trait(s).

For example, in some implementations, individual plant assets 234 may be stochastically (e.g., non-deterministically) selected, e.g., by a three-dimensional (“3D”) simulation module 236, and arranged in order to generate simulated plants. In some implementations, this stochastic selection may be weighted based on a variety of factors, such as observed or hypothetical environmental conditions, observed and/or hypothetical agricultural practices, etc. Put another way, individual plant assets may be weighted for stochastic selection based on these factors.

As mentioned above, 3D simulation module 236 may be configured to utilize plant assets 234 to generate simulated plants. For example, 3D simulation module 236 may stochastically select various numbers and/or types of plant assets for various numbers of simulated plants, and may generate 3D models of the simulated plants using the stochastically-selected assets in arrangements that may or may not also be at least partially stochastically selected. For example, some plants may tend to grow groups of leaves in layers. Accordingly, when generating a simulated version of such a plant, the general arrangement layers may be dictated by the plant type and age (e.g., in light of its environmental conditions), whereas the number, shape, and/or size of leaves per layer may be stochastically selected. The 3D simulation module 236 may simulate instances of plants grown in a plurality of different configurations and may simulate instances of plants that are lodged (e.g., fallen over).

A two-dimensional (“2D”) rendering module 238 may then take these 3D models and generate simulated 2D images 240, e.g., by projecting the 3D models onto 2D background(s). In various implementations, this 2D background, which also may be referred to (and function as) as “canvas,” may be a ground truth image captured by a digital camera of an area (e.g., a field), or may be a simulated environment. Such a simulated environment may be simulated by a computer, e.g., automatically or with guidance from an author. In other implementations, the 2D background may be drawn or painted. The simulated 2D images 240 generated by the 2D rendering module 238 may include images having different instances of camera occlusion. The distribution of the different instances of camera occlusion may be determined using real-life yield data. The simulated 2D images 240 generated by the 2D rendering module 238 may include images simulating a plurality of camera angles.

In some implementations, the simulated 2D images 240 generated by the 2D rendering module 238 may include simulated RGB images, simulated thermal images, simulated near-infrared images, simulated x-ray images, simulated photoluminescence images, etc. In some implementations, the 3D models generated by the 3D simulation module 236 may have properties associated with various materials and/or textures that map to RGB values, thermal values, near-infrared values, x-ray values, photoluminescence values, etc., and these properties may be used by the 2D rendering module 238 to generate the simulated 2D images 240, which may be RGB images, thermal images, near-infrared images, x-ray images, photoluminescence images, etc.

A labeling module 242 may be configured to process the simulated 2D images 240 in order to generate labeled simulated 2D images 244. Because 2D rendering module 238 incorporates the 3D plant models at known locations, labeling module 242 is able to label the simulated 2D images 240 generated by the 2D rendering module 238 with this information. These labels may take various forms, such as pixel-wise annotations, bounding shapes such as bounding boxes that encompass plants having targeted traits, etc. The labels may identify a number of leaves, fruits, flowers, and/or pods on the one or more simulated instances of the plant depicted in each of the simulated 2D images 240. Additionally or alternatively, the labels may identify a weight or volume yield associated with the one or more simulated instances of the plant depicted in each of the simulated 2D images 240. The aforementioned labels may describe both a visible portion and an occluded portion of the one or more simulated instances of the plant depicted in each of the simulated 2D images 240.

A training module 246 may be configured to apply data indicative of labeled simulated 2D images 244—e.g., the images themselves or embeddings generated therefrom—as inputs across one or more machine learning models from database 120 mentioned previously. The one or more machine learning models may include, for instance, a regression model that is intended to make an agricultural prediction.

The agricultural prediction (e.g., predicted crop yield in terms of number of leaves, fruits, flowers, pods, etc., or a weight or volume yield) based on such a machine learning model may be compared, e.g., by training module 246 as part of supervised training, to the labels associated with labeled simulated 2D images 244. Any difference(s) or “error” between the annotations and the labels may be used by training module 246 to train the machine learning model, e.g., using techniques such as gradient descent, back propagation, etc. Once trained, the machine learning model can be used by inference module 118 as described previously with FIG. 1. In some implementations, the training module 246 may be further tuned using real yield data (e.g., labeled images of actual crops), in addition to training the model using the labeled simulated images. In some implementations, inference module 118 and training module 246 may be combined.

In some implementations, the 3D simulation module 236 and/or the training module 246 may determine which of the simulated plants generated by 3D simulation module 236 are realistic (e.g., based on a confidence level of such plants appearing in an actual crop), and the model may be constrained to account for only realistic plants. For example, the training module 246 may use only simulated 2D images 240 that depict realistic plants in training the one or more machine learning models from database 120.

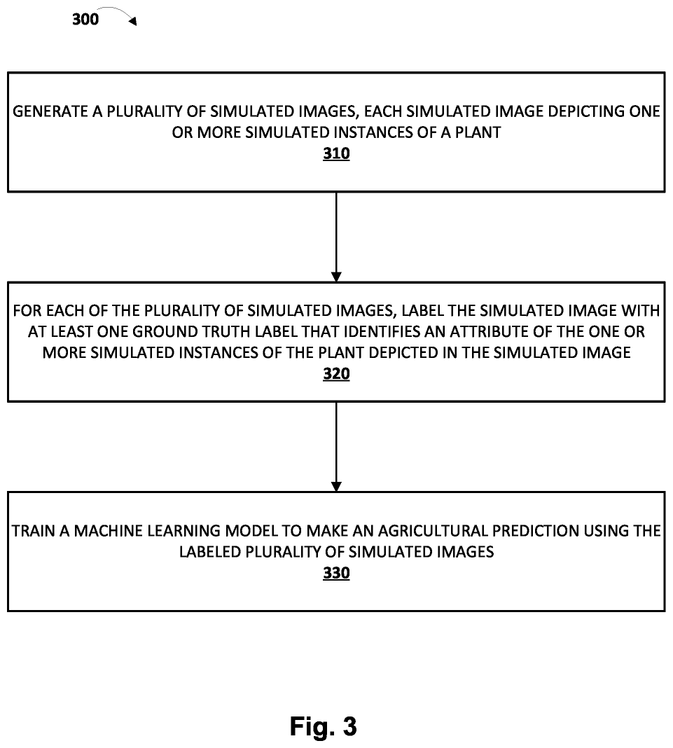

FIG. 3 depicts a flowchart illustrating an example method 300 of automatically generating labeled simulated images and using the labeled simulated images to train a machine learning model to make an agricultural prediction (e.g., to predict crop yield). For convenience, the operations of the method 300 are described with reference to a system that performs the operations. This system of method 300 includes one or more processors and/or other component(s) of various computer systems. Moreover, while operations of method 300 are shown in a particular order, this is not meant to be limiting. One or more operations may be reordered, omitted, or added.

At block 310, the system, e.g., by way of 3D simulation module 236 and 2D rendering module 238, generates a plurality of simulated images, each simulated image depicting one or more simulated instances of a plant. In some implementations, 3D simulation module 236 stochastically selects and arranges individual plant assets 234 in order to generate 3D models of one or more simulated instances of one or more plants. In some implementations, the 3D simulation module 236 may simulate instances of plants grown in a plurality of different configurations and may simulate instances of plants that are lodged.

Still referring to block 310, the two-dimensional (“2D”) rendering module 238 may then take these 3D models generated by the 3D simulation module 236 and generate simulated 2D images 240, e.g., by projecting the 3D models onto 2D background(s). The simulated 2D images 240 generated by the 2D rendering module 238 may include images having different instances of camera occlusion. The distribution of the different instances of camera occlusion may be determined using real-life yield data. The simulated 2D images 240 generated by the 2D rendering module 238 may include images simulating a plurality of camera angles. In some implementations, the simulated 2D images 240 generated by the 2D rendering module 238 may include simulated thermal images and/or simulated near-infrared images.

At block 320, for each of the plurality of simulated images from block 310, the system, by way of labeling module 242, labels the simulated image with at least one ground truth label that identifies an attribute of the one or more simulated instances of the plant depicted in the simulated image. The attribute may describe both a visible portion and an occluded portion of the one or more simulated instances of the plant depicted in the simulated image.

Still referring to block 320, because 2D rendering module 238 incorporates the 3D plant models at known locations, labeling module 242 is able to label the simulated 2D images 240 generated by the 2D rendering module 238 with this information to generate labeled simulated 2D images 244. These labels may take various forms, such as pixel-wise annotations, bounding shapes such as bounding boxes that encompass plants having targeted traits, etc. The labels may identify a number of leaves, fruits, flowers, and/or pods on the one or more simulated instances of the plant depicted in each of the simulated 2D images 240. Additionally or alternatively, the labels may identify a weight or volume yield associated with the one or more simulated instances of the plant depicted in each of the simulated 2D images 240. The aforementioned labels may describe both a visible portion and an occluded portion of the one or more simulated instances of the plant depicted in each of the simulated 2D images 240.

At block 330, the system, by way of training module 246, trains a machine learning model to make an agricultural prediction (e.g., to predict crop yield) using the labeled plurality of simulated images from block 320. The training module 246 may be configured to apply data indicative of labeled simulated 2D images 244—e.g., the images themselves or embeddings generated therefrom—as inputs across one or more machine learning models from database 120 mentioned previously, e.g., a regression model that is intended to predict crop yield.

Still referring to block 330, the agricultural prediction (e.g., predicted crop yield in terms of number of leaves, fruits, flowers, pods, etc., or a weight or volume yield) based on such a machine learning model may be compared, e.g., by training module 246 as part of supervised training, to the labels associated with labeled simulated 2D images 244. Any difference(s) or “error” between the annotations and the labels may be used by training module 246 to train the machine learning model, e.g., using techniques such as gradient descent, back propagation, etc. Once trained, the machine learning model can be used by inference module 118 as described previously with FIG. 1.

Still referring to block 330, in some implementations, the machine learning model may be further tuned using real yield data (e.g., labeled images of actual crops), in addition to training the model using the labeled simulated images.

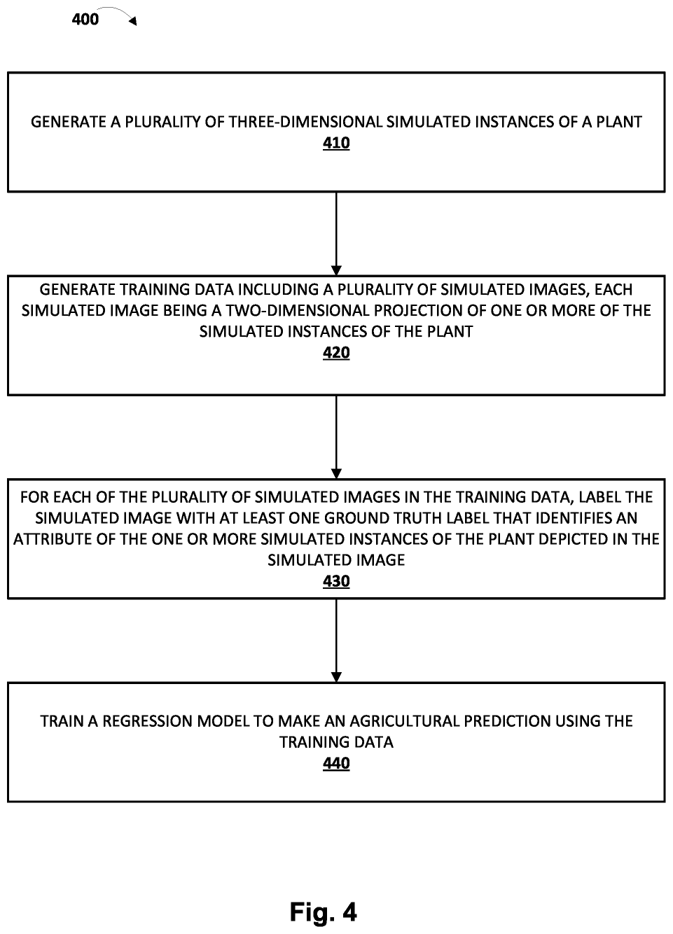

FIG. 4 depicts a flowchart illustrating an example method 400 of automatically generating labeled simulated images and using the labeled simulated images to train a machine learning model to make an agricultural prediction (e.g., to predict crop yield). For convenience, the operations of the method 400 are described with reference to a system that performs the operations. This system of method 400 includes one or more processors and/or other component(s) of various computer systems. Moreover, while operations of method 400 are shown in a particular order, this is not meant to be limiting. One or more operations may be reordered, omitted, or added.

At block 410, the system, e.g., by way of 3D simulation module 236, generates a plurality of three-dimensional simulated instances of a plant. In some implementations, 3D simulation module 236 stochastically selects and arranges individual plant assets 234 in order to generate 3D models of simulated instances of one or more plants. In some implementations, the 3D simulation module 236 may simulate instances of plants grown in a plurality of different configurations and may simulate instances of plants that are lodged.

At block 420, the system, e.g., by way of 2D rendering module 238, generates training data including a plurality of simulated images, each simulated image being a two-dimensional projection of one or more of the simulated instances of the plant. In some implementations, the two-dimensional (“2D”) rendering module 238 may take the 3D models generated at block 410 by the 3D simulation module 236 and generate simulated 2D images 240, e.g., by projecting the 3D models onto 2D background(s). The simulated 2D images 240 generated by the 2D rendering module 238 may include images having different instances of camera occlusion. The distribution of the different instances of camera occlusion may be determined using real-life yield data. The simulated 2D images 240 generated by the 2D rendering module 238 may include images simulating a plurality of camera angles. In some implementations, the simulated 2D images 240 generated by the 2D rendering module 238 may include simulated thermal images and/or simulated near-infrared images.

At block 430, for each of the plurality of simulated images in the training data from block 420, the system, by way of labeling module 242, labels the simulated image with at least one ground truth label that identifies an attribute of the one or more simulated instances of the plant depicted in the simulated image. The attribute may describe both a visible portion and an occluded portion of the one or more simulated instances of the plant depicted in the simulated image.

Still referring to block 430, because 2D rendering module 238 incorporates the 3D plant models at known locations, labeling module 242 is able to label the simulated 2D images 240 generated by the 2D rendering module 238 with this information to generate labeled simulated 2D images 244. These labels may take various forms, such as pixel-wise annotations, bounding shapes such as bounding boxes that encompass plants having targeted traits, etc. The labels may identify a number of leaves, fruits, flowers, and/or pods on the one or more simulated instances of the plant depicted in each of the simulated 2D images 240. Additionally or alternatively, the labels may identify a weight or volume yield associated with the one or more simulated instances of the plant depicted in each of the simulated 2D images 240. The aforementioned labels may describe both a visible portion and an occluded portion of the one or more simulated instances of the plant depicted in each of the simulated 2D images 240.

At block 440, the system, by way of training module 246, trains a regression model to make an agricultural prediction using the training data generated at block 420 and labeled at block 430. The training module 246 may be configured to apply data indicative of labeled simulated 2D images 244—e.g., the images themselves or embeddings generated therefrom—as inputs across one or more machine learning models from database 120 mentioned previously, e.g., a regression model that is intended to predict crop yield.

Still referring to block 440, the agricultural prediction (e.g., predicted crop yield in terms of number of leaves, fruits, flowers, pods, etc., or a weight or volume yield) based on such a machine learning model may be compared, e.g., by training module 246 as part of supervised training, to the labels associated with labeled simulated 2D images 244. Any difference(s) or “error” between the annotations and the labels may be used by training module 246 to train the machine learning model, e.g., using techniques such as gradient descent, back propagation, etc. Once trained, the machine learning model can be used by inference module 118 as described previously with FIG. 1.

Still referring to block 440, in some implementations, the machine learning model may be further tuned using real yield data (e.g., labeled images of actual crops), in addition to training the model using the labeled simulated images.

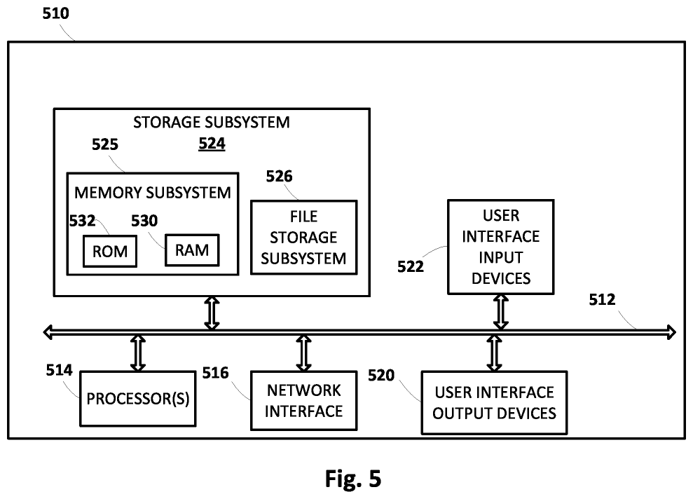

FIG. 5 is a block diagram of an example computing device 510 that may optionally be utilized to perform one or more aspects of techniques described herein. Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In some implementations in which computing device 510 takes the form of a HMD or smart glasses, a pose of a user's eyes may be tracked for use, e.g., alone or in combination with other stimuli (e.g., blinking, pressing a button, etc.), as user input. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, one or more displays forming part of a HMD, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of methods 300 and 400 described herein, as well as to implement various components depicted in FIGS. 1 and 2.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented by one or more processors, the method comprising:
generating a plurality of simulated images, each simulated image depicting one or more simulated instances of a plant;
for each of the plurality of simulated images, labeling the simulated image with at least one ground truth label that identifies an attribute of the one or more simulated instances of the plant depicted in the simulated image, wherein the attribute describes both a visible portion and an occluded portion of the one or more simulated instances of the plant depicted in the simulated image; and
training a machine learning model to make an agricultural prediction using the labeled plurality of simulated images.

2. The method according to claim 1, wherein the at least one ground truth label identifies a number of leaves, fruits, flowers, or pods on the one or more simulated instances of the plant depicted in the simulated image.

3. The method according to claim 1, wherein the at least one ground truth label identifies a weight or volume yield associated with the one or more simulated instances of the plant depicted in the simulated image.

4. The method according to claim 1, wherein the plurality of simulated images comprises images having different instances of camera occlusion.

5. The method according to claim 4, wherein a distribution of the different instances of camera occlusion is determined using real-life yield data.

6. The method according to claim 1, wherein the plurality of simulated images include images simulating a plurality of camera angles.

7. The method according to claim 1, wherein the plurality of simulated images include images of simulated instances of plants grown in a plurality of different configurations.

8. The method according to claim 1, wherein the plurality of simulated images include images of simulated instances of plants that are lodged.

9. The method according to claim 1, wherein the plurality of simulated images include simulated thermal images.

10. The method according to claim 1, wherein the plurality of simulated images include simulated near-infrared images.

11. A computer program product comprising one or more non-transitory computer-readable storage media having program instructions collectively stored on the one or more computer-readable storage media, the program instructions executable to:
generate a plurality of three-dimensional simulated instances of a plant;
generate training data comprising a plurality of simulated images, each simulated image being a two-dimensional projection of one or more of the simulated instances of the plant;
for each of the plurality of simulated images in the training data, labeling the simulated image with at least one ground truth label that identifies an attribute of the one or more simulated instances of the plant depicted in the simulated image, wherein the attribute describes both a visible portion and an occluded portion of the one or more simulated instances of the plant depicted in the simulated image; and
train a regression model to make an agricultural prediction using the training data.

12. The computer program product according to claim 11, wherein the at least one ground truth label identifies leaf sizes, leaf shapes, leaf spatial and numeric distributions, branch sizes, branch shapes, flower size, or flower shapes on the one or more simulated instances of the plant depicted in the simulated image.

13. The computer program product according to claim 11, wherein the at least one ground truth label identifies a weight or volume yield associated with the one or more simulated instances of the plant depicted in the simulated image.

14. The computer program product according to claim 8, wherein the plurality of simulated images comprises images having different instances of camera occlusion.

15. The computer program product according to claim 14, wherein a distribution of the different instances of camera occlusion is tuned using real-life yield data.

16. The computer program product according to claim 14, wherein the plurality of simulated images include images simulating a plurality of camera angles.

17. The computer program product according to claim 14, wherein the plurality of simulated images include images of simulated instances of plants grown in a plurality of different configurations.

18. The computer program product according to claim 14, wherein the plurality of simulated images include images of simulated instances of plants that are lodged.

19. A system comprising:
a processor, a computer-readable memory, one or more computer-readable storage media, and program instructions collectively stored on the one or more computer-readable storage media, the program instructions executable to:
generate a plurality of simulated images, each simulated image depicting one or more simulated instances of a plant;
for each of the plurality of simulated images, label the simulated image with at least one ground truth label that identifies an attribute of the one or more simulated instances of the plant depicted in the simulated image, wherein the attribute describes both a visible portion and an occluded portion of the one or more simulated instances of the plant depicted in the simulated image; and
train a regression model to make an agricultural prediction using the labeled plurality of simulated images.

20. The system according to claim 19, wherein the at least one ground truth label identifies a number of leaves, fruits, flowers, or pods on the one or more simulated instances of the plant depicted in the simulated image.
